(19) United States
(12) Patent Application Publication
(10) Pub. No.: US 2022/0351024 A1
(43) Pub. Date: Nov. 3, 2022

(54) METHOD FOR DETECTING UNCOMMON INPUT

(71) Applicant: Telefonaktiebolaget LM Ericsson (publ), Stockholm (SE)

(72) Inventors: Ali S. KHAYRALLAH, Mountain View, CA (US); Meral SHIRAZIPOUR, San Jose, CA (US); Julien FORGEAT, San Jose, CA (US); Michael LILJENSTAM, Sunnyvale, CA (US)

(73) Assignee: Telefonaktiebolaget LM Ericsson (publ), Stockholm (SE)

(21) Appl. No.: 17/620,588

(22) PCT Filed: Jun. 24, 2019
(86) PCT No.: PCT/IB2019/055314

§ 371 Date: Dec. 17, 2021

(51) Int. Cl. G06N 3/04; G06N 3/08

(52) U.S. Cl. CPC G06N 3/0472; G06N 3/08

(57) ABSTRACT

A method determines outlier inputs for a machine learning system. The method includes receiving a classification and activation values of a trained classifier or a first input processed by the trained classifier, determining whether an entropy score derived from the first input is below a threshold entropy-based distance metric, and changing the classification in response to the entropy score not being below the threshold.

### TECHNICAL FIELD

Embodiments of the invention relate to the field of machine learning; and more specifically, to a process for detecting outlier data to screen the outlier data from machine learning processes to improve accuracy and security.

### BACKGROUND ART

Machine learning (ML) is a computer implemented process that consists in utilizing algorithms, models, and statistics to configure a computer system to perform operations without using explicit instructions, instead relying on processes of pattern detection and inference. ML involves a model to generalize key features from given input data and to extract patterns. A key feature could be an element of the input data set as is, or a combination of the data processed by a formula (e.g. a mean value of a subset of the input data could be a feature). The ML model is trained with data and acquires knowledge without human intervention. The process of feature engineering requires some domain expertise and is usually a difficult process.

Nonetheless, the created generalized ML model can be used on new data to perform a similar task for which the model was trained. For example, a trained generalized ML model can classify the input data into a category. ML is different from how computers have been used in past years, where all the knowledge of a program is explicitly and formally programmed by a human operator. Due to these characteristics of ML, ML introduces non-deterministic execution behavior and black box non-explainability problems that open the door to new types of software vulnerabilities for applications that utilize ML. These vulnerabilities could cause the ML to produce wrong and unexpected results. In one example, ML can be vulnerable to producing inaccurate results by inputting carefully crafted and arranged input data. The use of such data to cause improper program behavior is called an adversarial attack.

For example, ML may be used for navigation in an autonomous vehicle. The ML takes input from optical sensors to identify road conditions and traffic patterns. If the ML encounters an image of a traffic signal that has been modified is a specific manner that may not be easily noticeable to the eye, then the ML may misidentify the traffic signal and cause an accident. In another example of an adversarial attack, data traffic may be manipulated to get around a filter or firewall that is implemented using ML such that the ML misidentifies the data traffic as normal traffic, not by mimicking normal traffic, which the ML is likely to be heavily trained to distinguish but by present data traffic that is unexpected and the ML is not properly trained to detect, causing an improper categorization as ‘normal’ data traffic.

### SUMMARY

In one embodiment, a method determines outlier inputs for a machine learning system. The method includes receiving a classification and activation values of a trained classifier or a first input processed by the trained classifier, determining whether an entropy score derived from the first input is below a threshold entropy-based distance metric, and changing the classification in response to the entropy score not being below the threshold.

In another embodiment, an electronic device executes the method for determining outlier inputs for a machine learning system. The electronic device includes a non-transitory computer-readable medium having stored therein an outlier identifier, and a processor coupled to the non-transitory computer-readable medium, the processor to execute the outlier identifier, the outlier identifier to receive a classification and activation values of a trained classifier or a first input processed by the trained classifier, to determine whether an entropy score derived from the first input is below a threshold entropy-based distance metric, and to change the classification in response to the entropy score not being below the threshold.

In a further embodiment, a computing device implements a plurality of virtual machines, the plurality of virtual machines to implement network function virtualization (NFV), where at least one virtual machine from the plurality of virtual machines implements a method for determining outlier inputs for a machine learning system. The computing device includes a non-transitory computer-readable medium having stored therein an outlier identifier, and a processor coupled to the non-transitory computer-readable medium, the processor to execute the at least one virtual machine from the plurality of virtual machines, the at least one virtual machine to execute the outlier identifier, the outlier identifier to receive a classification and activation values of a trained classifier or a first input processed by the trained classifier, to determine whether an entropy score derived from the first input is below a threshold entropy-based distance metric, and to change the classification in response to the entropy score not being below the threshold.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating aspects of the ML pipeline that factor into the security of the ML model.

FIG. 2 is a diagram illustrating the setting in which the embodiments of the outlier identification process may operate.

FIG. 3 is a flowchart of one embodiment of the operation of the outlier identifier.

FIG. 4 is a diagram that illustrates an example of a neural network organization with layers 1-L.

FIG. 5 is a diagram of an example operation of an individual neuron in a group of neurons in layer l that has h neurons.

FIG. 6 is a diagram of example neuron values.

FIG. 7 is a diagram of an example trained classifier trained using a data set with data items 1-m that is input into an ML model and organized into classes that are divided into sub-classes.

FIG. 8 is a diagram illustrating an example classification process.

FIG. 9A illustrates connectivity between network devices (NDs) within an exemplary network, as well as three exemplary implementations of the NDs, according to some embodiments of the invention.

FIG. 9B illustrates an exemplary way to implement a special-purpose network device according to some embodiments of the invention.

FIG. 9C illustrates various exemplary ways in which virtual network elements (VNEs) may be coupled according to some embodiments of the invention.

FIG. 9D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 9E illustrates the simple case of where each of the NDs implements a single NE, but a centralized control plane has abstracted multiple of the NEs in different NDs into (to represent) a single NE in one of the virtual network(s), according to some embodiments of the invention.

FIG. 9F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 10 illustrates a general purpose control plane device with centralized control plane (CCP) software 1050), according to some embodiments of the invention.

### DETAILED DESCRIPTION

The following description describes methods and apparatus for detecting outlier inputs for machine learning systems. The embodiments include a process for detecting outlier inputs that may be improperly processed by a machine learning system. The embodiments include determining a reference probability distribution for a trained classifier of the machine learning system. New inputs to the machine learning system are processed and compared to the reference probability distribution to determine whether a deviation from the reference probability distribution exceeds a configurable threshold level. Where the deviation exceeds the threshold level the input can be considered an outlier and can be blocked from inclusion in the machine learning model and the output of the trained classifier can be flagged or blocked to prevent improper operation of the machine learning system.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Deep Learning

Deep learning (DL) is a branch of ML that can be implemented as a multi-layer feedforward perceptron neural network (NN). A neural network is a network of artificial neurons or nodes that are used for solving artificial intelligence problems. In general, DL does not require a domain (i.e., a subject matter) expert to perform feature engineering (i.e., program design), because a DL program discovers the feature engineering on its own. DL utilizes the concept of representation learning. Representation learning uses ML to learn the best representation of the input data. This is needed because in complex ML tasks (e.g., identifying objects in a picture), it is very difficult to extract the right features from the raw data. This is because the right set of features are different for each input training data set, as they are influenced by the factors of variation. For example, if the task is the detection of a car, the position (viewing angle), lighting/color, types of cars, and similar factors are factors of variation. The idea of representation learning is to learn these factors of variation and to use ML to learn the best representation of input data that can give the best results in terms of the primary ML task.

The task of discovering these factors of variation is by itself very difficult, and this is where deep learning assists. Deep learning solves the problem of representation learning by allowing the ML model to build complex models out of simpler models. The problem of, for example, detecting an object in an image, is to take the raw input and have each NN layer learn a simple part of the problem, such as identifying edges, contours, parts, colors, or similar features. For sake of clarity and conciseness, the embodiments are described with relation to the example of deep neural networks such as convolutional neural networks (CNN) used for image classification. One skilled in the art would appreciated that the method of the embodiments is valid for other network types and can be applied to other ML models as well.

### Terminology

Most of the examples described in regard to the embodiments fall under the class of supervised learning, where the ML model is trained with training data (e.g. for CNN image classification, a set of correctly labeled images are used to train the model). The trained ML model is used to predict the class of unlabeled inference data. During the training phase, training data is split into validation data and test data. Validation data is used to further tune the model's hyperparameters and test data is used to assure the accuracy of the model. A hyperparameter is a parameter of the ML model that can influence the learning of the ML model. Hyperparameters values are set before a training process begins for the ML model. The hyperparameters can be of the continuous or integer type. The hyperparameters can be used for tuning performance of the ML model. The variables that will serve as hyperparameters may not be known at the outset of the generation and training of an ML model and can be identified after, e.g., based on their influence on the training process and performance of the ML model. Once trained, the ML is used in real world. For sake of clarity the embodiments focus on training data and inference data.

Machine Learning Security

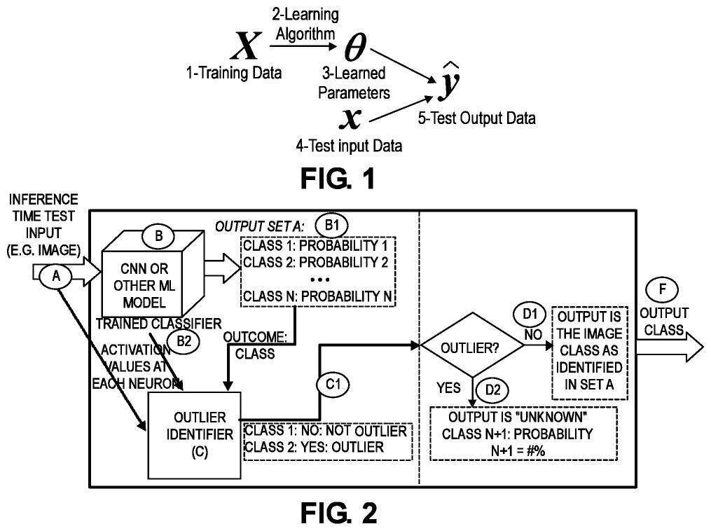

FIG. 1 is a diagram illustrating aspects of the ML pipeline that factor into the security of the ML model. Traditional security programs can utilize ML for implementing security (e.g. malware detection). Traditional security can also include security solutions against attacks that use ML; e.g. password guessing, astroturfing (hidden paid Internet posters), and similar security issues that relate to ML. However, the security of ML systems is distinct from these areas of traditional security. Each of the elements 1 to 4 in FIG. 1 can be prone to attacks. The attacker's strength comes from access to elements (1) and (4), (2) and (3), and similar access. Points (2) and (3) refer to the ML model's architecture and weights (e.g., in a NN, support vector machine (SVM) or similar ML model).

The attacks can by defined as fitting various attack types, including an untargeted misclassification attack and a source-targeted misclassification attack. An untargeted misclassification attack is when the attacker wants an input to be mis-classified from its correct class. A source-targeted misclassification attack (a.k.a. targeted attack) is when the attacker wants an input to be classified as an incorrect target class, which is usually harder.

At point (1) in FIG. 1, training data privacy may be compromised. An attacker has access to point (3) learned parameters and can recover the original (1) training data. This can happen where the model is published (e.g. medical prediction model trained on real patient data). Differential privacy (a theoretical framework) is implemented as treating the ML algorithm's access to training data as an access to a database. At a high level, the data is randomized by e.g. adding gaussian noise. The most prominent version of differential privacy is using Private Aggregation of Teacher Ensembles (PATE) where multiple teachers (ML models) are trained on a partial set of the whole data set. The output of all these teacher models is put together with some aggregation noise and used by the final student model.

Attacks against ML models (learning algorithms) can be classified as causative (manipulation of training data, e.g. see below) and exploratory (exploitation of the classifier, e.g. further below). At point (1) in FIG. 1, training set poisoning could occur. An attacker may have access to training set (1). This can happen in cases where data is collected in the wild (e.g. malware detection, spam detection). This can poison the model's (3) learned parameters and hence cause the output (5) to misclassify.

At point (4) in FIG. 1, adversarial attack examples can include a carefully crafted test input example that will cause the ML model to misclassify the input either as a targeted or untargeted attack. These attacks can include model theft, which involves the theft of the parameters of the model, by using the model with many inputs and observing the output. This cannot be prevented, but watermarking is one solution (i.e. generate strange outputs for certain inputs). Model theft can also make it easier to create adversarial examples, and, if differential privacy is not used, the original data may be recovered after recreating the model.

More on Adversarial Attack Examples

Adversarial attack input is an input that has been found by small (non-random) perturbations of the original input that maximizes the prediction error of the ML model (e.g. CNN). A significant aspect of ML models is that they perform very poorly on all possible input space. However, ML models perform very well on naturally occurring inputs they have been trained with. This holds for any model (linear or non-linear like NN). This means that unusual inputs are often classified as a known class by the ML model. The embodiments are based on this fact that adversarial attack examples are of low probability in the training set but have high-dimension in the solution space manifold. Furthermore, when it comes to adversarial attack inputs, it has been shown that the same adversarial inputs created for one ML model tend to also fool different ML models.

Overview

In the art, the mechanisms that exist to combat these adversarial attacks include adversarial training and certified defenses amongst other mechanisms. For sake of clarity and conciseness, the embodiments are described primarily in relation to these mechanisms.

With adversarial training, which is the primary solution utilized against adversarial attack examples, the ML model is trained against many adversarial attack examples. Training with adversarial attack examples can reduce misclassification when under attack. The problem is that these results are empirical (i.e., there is no proof that they will work all the time as it is impossible to generate and train against all possible adversarial attack examples). There is no way to know when it is time to update the ML model with new adversarial example training. Also, generating these adversarial attack examples may require specific domain knowledge. Further, there is no easy integration within an ML model's life cycle.

The other solution utilized are certified defenses. Certified defenses deal with the geometry of the model and proof that they are robust against attacks around a given test point. These methods do not generalize. Both these methods of defending against adversarial attacks require very specific expertise in the field (domain) to develop and test. The embodiments overcome these limitations of the art, by providing embodiments which are built on a heuristic based method to detect outlier inputs and can constantly adjust to new data with minimum domain expertise or machine learning expertise.

The embodiments use the frequency of occurrence of valid inputs during training to determine how far apart from this a given test input is. This way, a test input classification can be declared as outlier if it has not been seen during training. This is done by the comparison of a test input with a base probability created with the training data. The comparison uses a method to compute the distance of how far apart the model parameters are, between the base case and the test case. The method looks at the effect of a given input at inference time on the ML model's parameters (e.g. neurons of the deep NN (DNN)). The effect is compared between the base data and the test data to determine if the test data is an outlier (i.e. uncommon input).

The embodiments provide advantages over the art, where the embodiments detect outlier images that may be easy for the human eye, but for other type of inputs (e.g. Telco data) it may be a lot harder for a human to detect if the input belongs to the naturally occurring input space (i.e., those used during training). Hence the embodiments are even more useful for non-image cases (e.g., telecommunication data). The embodiments can be constantly fine-tuned (i.e., updated) and used in practice without the need for domain experts or machine learning experts.

The embodiments utilize an information distance metric (e.g. a Kullback-Leibler divergence) to classify inputs (e.g. images), as per how much their influence on the model's decision differs from base cases that are obtained from the good data used during training. In one embodiment, this base case is obtained only after the ML model is trained and not during the training. The base case is established by using the correct/good (naturally occurring) data used during the training and observing its impact on the trained model's internal behavior during inference. This creates a base case. Then in test mode, the inference time test input is observed and expected to have a similar impact on the ML model to the base case for that given class. If the input data differs by a given threshold, it is classified as outlier data.

The embodiments process input and classifications to identify outlier inputs. The inference time test input is classified as outlier if it differs too much from the base case. How the difference is computed, and example implementation details are set forth herein below.

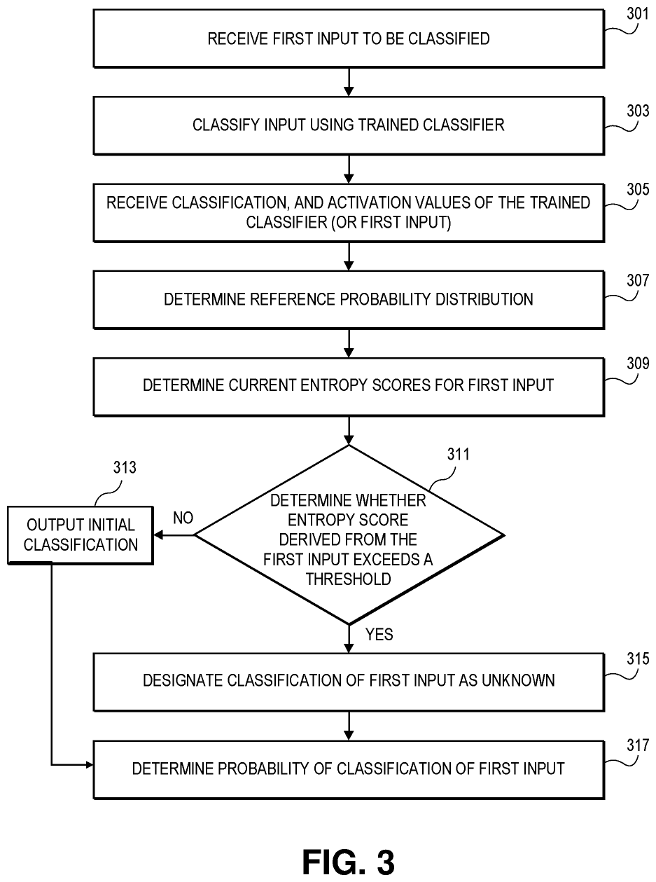

FIG. 2 is a diagram illustrating the setting in which the embodiments of the outlier identification process may operate. The process can begin at point A where the inference time test input is fed to the trained classifier (B) (e.g., a CNN or similar ML Model). The inference time test input can be any type of data to be classified by the trained classifier, e.g., an image, telecommunication data or similar input data. The trained classifier (B) performs classification (i.e., inference) and assigns the input to a given class (i.e., category) (B1). The output of B1 {Set A} is generated with the classification of the input, and/or probability assigned to each class (e.g. a cat image is classified as 95% cat). The set of activation values at each neuron of the CNN at inference time is output (B2) to outlier identifier (C). The outlier identifier also can receive a copy of the inference time test input (A). In addition, the output {Set A} is provided to the outlier identifier (C) to determine whether the inference time test input (A) is an outlier.

The outlier identifier (C) performs the outlier classification process, as described in further detail herein below, to determine if the input is an outlier for the classification done by the trained classifier B. As mentioned the outlier identifier C in one embodiment includes B1 (i.e., the outcome of the classification done by the trained classifier model), and the activation values B2 at each neuron of the trained classifier model or the equivalent thereof. In another embodiment, alternatively to activation values, the actual inference time test input (A) could be given to the outlier identifier, which would then need a copy of the model (B) (e.g., the CNN or similar ML model) to run the inference time test input and collect the activation values per neuron.

The outlier identifier (C) determines whether the inference time test input is determined to be an outlier or not. The outlier identifier (C) outputs the classification (C1) as class 1, No: not an outlier or class 2, yes, an outlier (optionally with a probability assigned to each of the two classes). The outlier classification can then be utilized by an associate application (e.g., D1). If the inference time test input is not an outlier, the output of the trained classifier (B) is valid and can be utilized (i.e., output B1) as an output F.

If the inference time test input is an outlier, then the process can output a final classification output (which overrides the trained classifier) indicating the inference time test input is ‘unknown.’ In one embodiment, the output includes a class N+1: “Unknown” with a probability (e.g. 97%). Optionally, the C1 probability could be used to adjust the probabilities of the classes B1 output by the trained classifier B.

The associated applications should decide how to use the final output (F) or (D2) if determined to be an outlier input. For example, a “self-driving car” application should probably do a safe-stop, while an “image search engine” application could probably just omit the input. If not an outlier, the application can use the output at B1.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

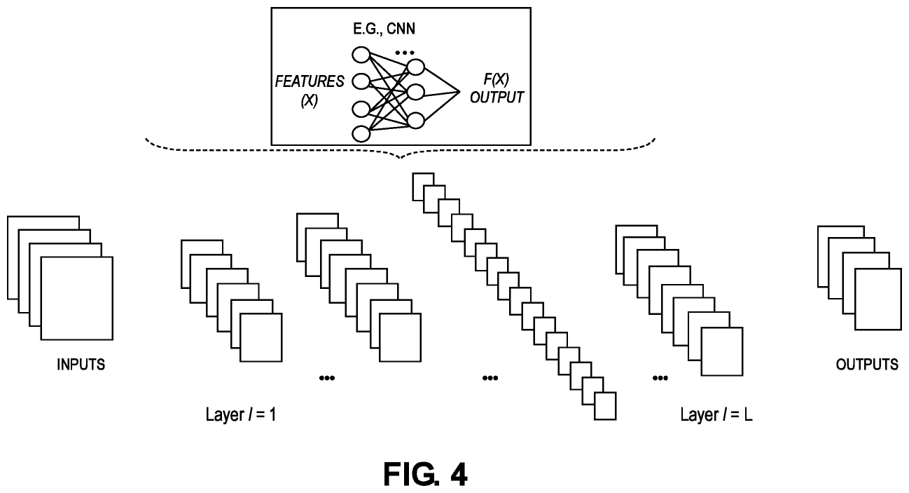

FIG. 3 is a flowchart of one embodiment of the operation of the outlier identifier. The embodiments of the outlier identifier operate in conjunction with a trained classifier. The outlier identifier operates after a first test input is received by the trained classifier (Block 301). The trained classifier then processes the first test input to classify the first test input (Block 303). The output of the trained classifier can be a classification or set of classifications. In some embodiments, the probabilities of each classification or the primary classification can also be included in the output.

The trained classifier can be an ML model such as a NN. In the example embodiments, the outlier identifier works on a fully trained deep neural network (e.g. CNN). This example is provided by way of example and not limitation. The outlier identifier receives the classification and activation values of the trained classifier (Block 305). In other embodiments, a copy of the ML model and the first test input (referred to in the diagram as the ‘first input’) are received. This information is utilized to determine a reference baseline for identifying outlier inputs.

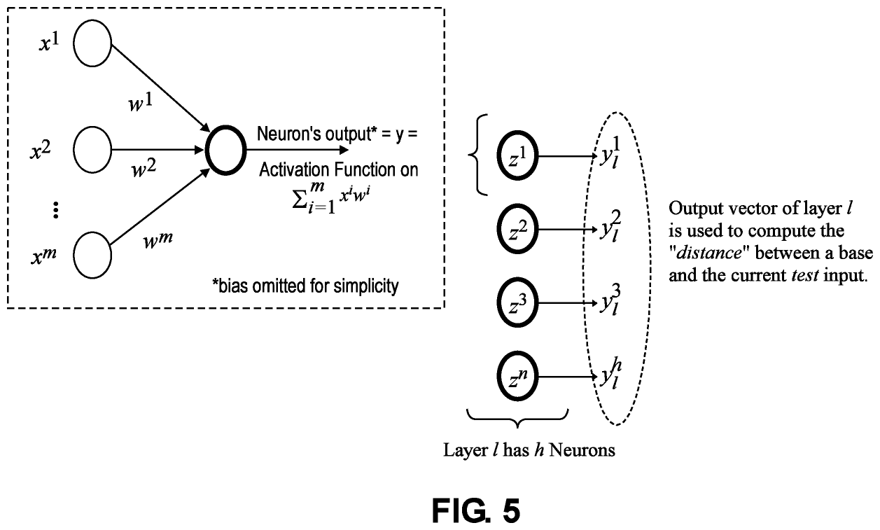

The outlier identifier can be utilized with other types of ML models and NNs. The outlier identifier process comprises determining the relative amount of change (entropy) an input has on the output of the neurons in the NN (e.g., in a DNN). FIG. 4 illustrates an example of a neural network organization with layers 1-L. This example neural network is simplified for sake of illustration. The neural network can have any number of levels between the input and output with any number of nodes in each layer with any combination of connections between the nodes. The outlier identifier can work with a neural network such as this or similar ML models.

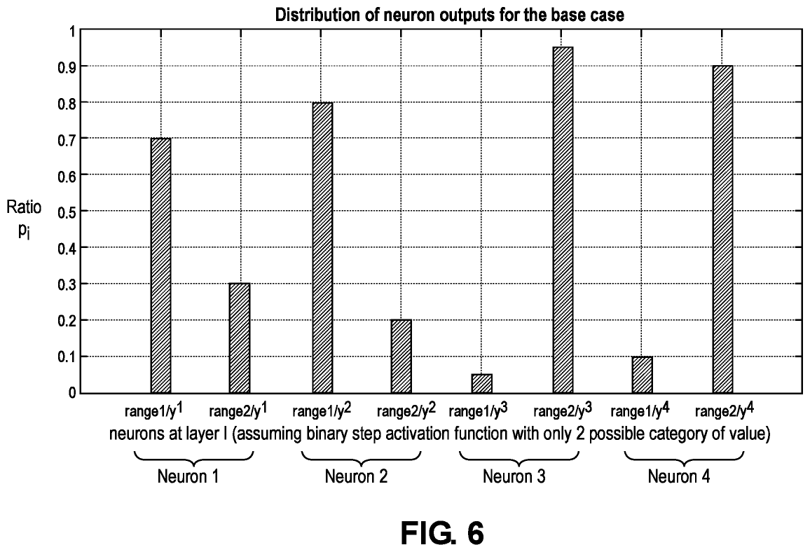

FIG. 5 is a diagram of an example operation of an individual neuron in a group of neurons in layer l that has h neurons. The neural network of the example FIG. 4 can have each neuron function as illustrated in FIG. 5. Each neuron implements an activation function that may be weighted or biased. The combination of outputs of neurons in a layer is used to compute a distance (i.e., change) between a base or reference state of the NN and the state of the NN after processing a current test input.

Returning to FIG. 3, one example way to compute the relative change introduced by a new test input is by using processes for identifying entropy change, e.g., the Kullback-Leibler (K-L) divergence, or relative entropy. The outlier identifier can use a process where the entropy is defined as an “information score S.” This information score is the amount of new information this new test input brings to the base probability; or how much its addition to the base set disturbs the base probability. The outlier identifier computes how the new probability distribution is different from a base one (the reference probability distribution).

The computation of the “information score S” includes the computation of entropy between a base (expected probability pₖ,) and the observation (rₖ,). The expected probability is obtained using good (i.e., reliable or verified) training data. The observation probability is obtained by adding the test input to the observations up to now (i.e., the current state of the ML model).

S Score Computation

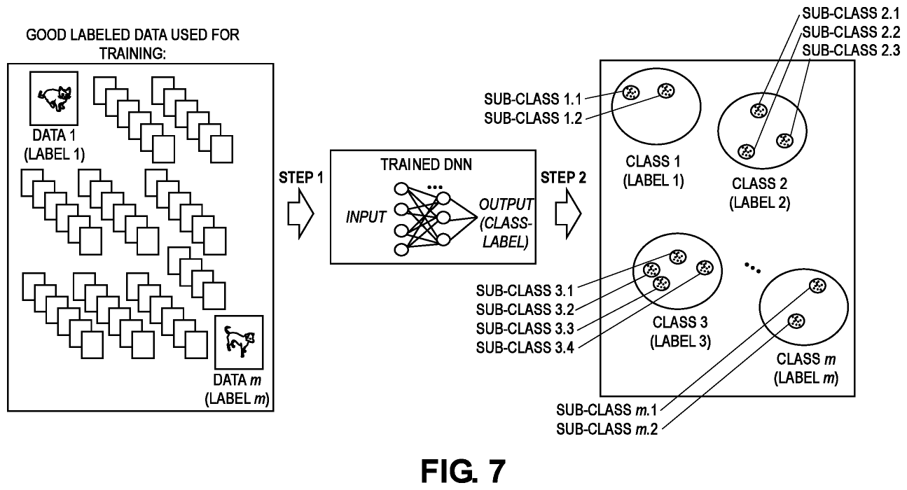

Equation 1 below shows how the information score S is computed with the currently observed data (rₖ) being compared to a previously observed base (probability Pₖ). The value of k is the number of neurons in the ML model times the number of possible activation output values. So, in the example of FIG. 6 it would be K=4 neurons*2 values=8. If the activation function output is a continuous number, then ranges of values are to be taken as categorical values (number of ranges is a hyperparameter to tune). For example, if the activation function output is any value between 0 and 1, then in some embodiment 5 categories could be used: 1: [0-0.2[, 2:[0.2-0.4[, 3:[0.4-0.6[, 4:[0.6-0.8[, and 5:[0.8-1]. In this case K would become 4 neurons*5=20.

$$Equation 1 - Formula to compute the entropy or information score {S}_{i , j} for category i , sub - category j$$

$$Information score {S}_{i , j} = {\sum }_{k = 1}^{K} {r}_{k} \vert log ( \frac{{r}_{k}}{{p}_{k}} ) \vert$$

Since this equation is a summation, it is possible to know which neurons/values caused the most entropy and the least entropy as the base probability database is created. This information is useful for the calibration step described herein below.

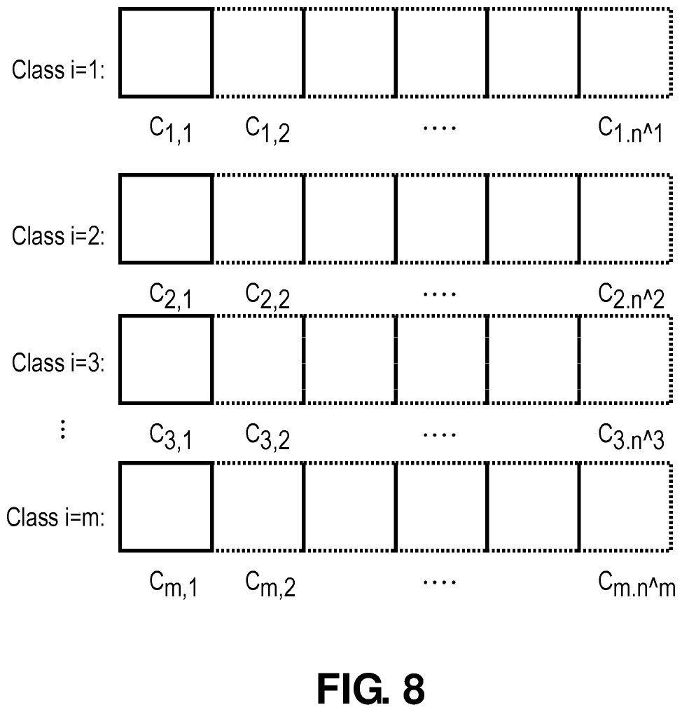

To determine entropy change the outlier identifier first determines the reference (base) probability distribution (e.g., as a base or reference database) (Block 307). While the flowchart illustrates the computation of the base probability distribution in an example sequence, the base probability distribution can be computed asynchronously at any time prior to this point. The base probability distribution can be stored as a base probability database (for example, this can be stored at the outlier identifier or at a remote location accessible to the outlier identifier). Multiple reference probabilities are computed for each class (e.g. classes can be labels such as cat, dog, etc. in the examples). As shown in FIG. 7, the trained classifier (e.g., a trained DNN) is trained using a data set with data items 1-m that is input into the ML model (e.g., the DNN) and organized into classes that are divided into sub-classes (i.e. sub-category with the same label, cat-1, cat-2, etc., dog-1, dog-2, etc.). The sub-class is determined based on the DNN state created during inference. The sub-classes can be identified by comparing the inference states of the inputs to find groupings. Two different inference states of the DNN can be compared using various distance functions as mentioned previously. One example is to use the entropy based “information score.” The information scores can be sorted to determine classes or sub-classes with minimum distances.

Depending on which activation function is used, the output of each neuron will be a given value. For certain activation functions like the binary step, the output is either zero or one. However, for other activation functions, the output may have a continuous value. For those cases, ranges of values could be used as categories. Binary activation functions are used for sake of simplicity in some of the examples.

The reference probability distribution can be computed using different processes (e.g., different algorithms). Two different embodiments are described herein below by way of example and not limitation.

### First Embodiment Process

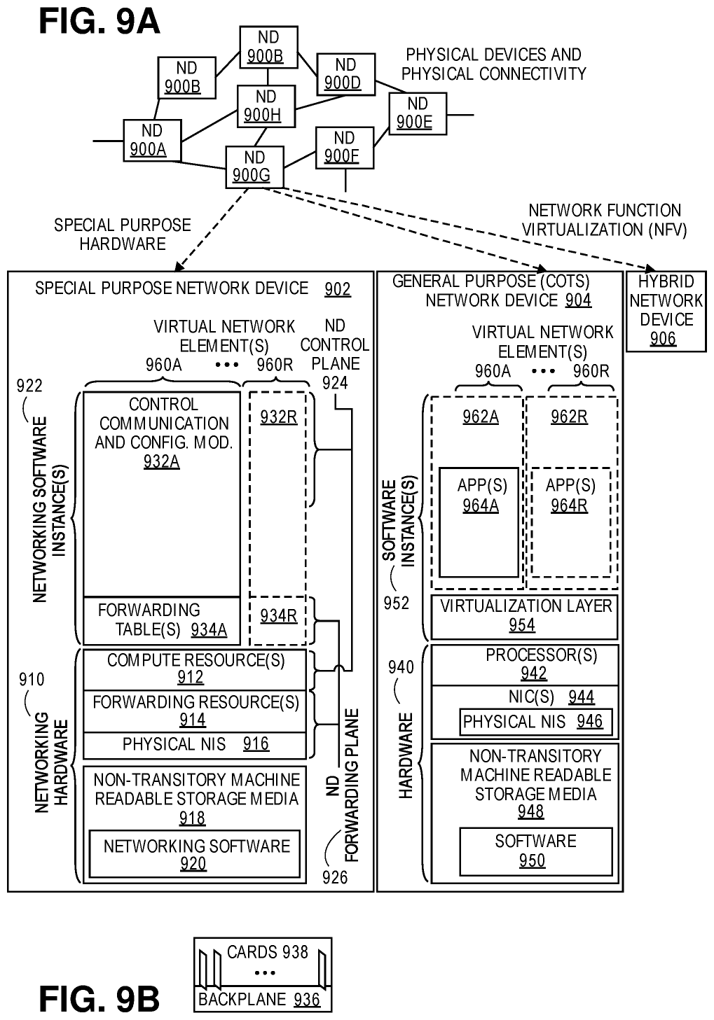

The first embodiment assigns an input to a sub-class based on its DNN neuron weight information and updates the probability distribution of the sub-class in question. Computing the entropy means that using any distance computation method like K-L etc., the process computes the distance or information score (entropy) of the sub-class using the current base probability and the probability distribution after assigning the current input to the sub-class (Block 309). This can be expressed as pseudocode in reference to FIG. 8, which is a diagram illustrating an aspect of an example classification process. The pseudo code can be expressed as:

```
  FOR each of the Input Classes i ∈ 1 to m (i.e. all inputs with the same label: e.g. cat,
etc.) {
        Set I=|i| (number of input samples for that class i)
        Initialize sub-class C_{i,1} by ASSIGNING the first input sample h=1 to it
        Set nⁱ= 1.
        FOR each of the subsequent inputs h ∈ 2 to I (of class i) {
              FOR each of the sub-classes C_{i,j} , j ∈ i.1 to i. nⁱ {
                  COMPUTE THE ENTROPY SCORE S_{i,j} (i.e. compute the distance)
          }
  Select the sub-class C_{i,j} where the entropy S_{i,j} is the smallest.
    IF S_{i,j} < threshold Tᵢ {
          ASSIGN the current input h to that sub-class C_{i,j}
              }
              ELSE{
                nⁱ= nⁱ+1.
                Create a new sub-class C_{i,j=}nⁱ
                ASSIGN the current input h to the new sub-class C_{i,j=}nⁱ .
            }
      }
  }
```

In this embodiment, a Threshold Tᵢ is set per class i (this is a hyperparameter that can be fine-tuned during the process). All base probabilities per neuron per sub-class are stored as well as a counter that can keep track of the number of inputs assigned to each sub-class.

### Second Embodiment Process

This embodiment is an alternative to the first embodiment discussed above. This embodiment is based on a K-Means clustering algorithm (i.e., a method of vector quantization where K-means clustering seeks to partition n observations into clusters in which each observation belongs to the cluster with the nearest mean, which results in a partition of data space into Voronoi cells). In this embodiment, the process selects the best K value per input class as a hyperparameter to be tuned. Then the assignment of a sample input to the sub-class is equivalent to readjusting the centroids in the K-Means algorithm. As with the first embodiment, all base probabilities are per neuron per sub-class and are stored as well as a counter that can keep track of the number of inputs assigned to each sub-class. This embodiment can be used where there are an unknown number of sub-classes. A maximum number of sub-classes can be set for the process or a similar limitation implemented. This second embodiment can be expressed as pseudocode:

```
  FOR each of the Input Classes i ∈ 1 to m (i.e. all inputs with the same label: cat, etc.) {
      Set ni= Ki (K-mean algorithm-set arbitrary K for class i)
      Set I=|i| (number of input samples for that class i)
      Initialize sub-class C_{i,1} to C_{i, n\hat{ }i} by ASSIGNING the first inputs h=1 to nⁱ to them
      FOR each of the subsequent inputs h ∈ nⁱ +1 to I (of class i) {
        FOR each of the sub-classes C_{i,j} , j ∈ i.1 to i. nⁱ {
            COMPUTE THE ENTROPY SCORE Si,j (e.g. compute the distance)
          }
          ASSIGN the input h to the sub-class C_{i,j} where the entropy S_{i,j} is the
smallest
      }
    }
```

Both the first embodiment and the second embodiment are example clustering functions that can be used for determining the base probability distributions. Other clustering methods can also be used.

Returning to FIG. 3, once the reference probability distribution and the entropy scores derived from the model after the first input processing are determined, then this information can be applied to identify whether the first input is an outlier input (Block 311). The inputs processed by the outlier identifier can be the first input classification and the activation information of the neural network while in other embodiments, the ML model and the first input are provided to the outlier identifier. The outlier identification can be expressed as pseudocode below. The Tᵢ values used below do not have to be the same as the ones in the first embodiment of the probability distribution process. This Tᵢ value is also a hyperparameter to be tuned during the process.

```
Given label class i=i′ and input k= k′
IS_OUTLIER=TRUE
FOR each of the sub-classes C_{i,j} , j ∈ i.1 to i. nⁱ {
  COMPUTE THE ENTROPY SCORE S_{i,j}
  IF S_{i,j} < threshold Tᵢ {
      IS_OUTLIER=FALSE
        Break
  }
}
```

Alternatively, the example usage of this outlier identifier process could be modified to compute S_{i,j} with respect to all sub-classes and then use the closest to determine if not an outlier. Further, the count value can be used as a measure of the density of the sub-class (i.e. sampling fraction). The density of a sub-class could be used to adjust the threshold Tᵢ per sub-class (make the threshold smaller for sparse sub-classes, etc.).

For smaller (less dense) sub-classes, the IS_OUTLIER Boolean could be replaced by a confidence probability instead of 100% true or 100% false. For example, where the counter for a sub-class represents only 5% of the data samples for that class (e.g. sub-class created with 5% of all cat images used to create the base probability distribution database) then, if an input is associated to that sub-class, the probability of declaring it a non-outlier could be less than if assigned to a sub-class with 70% of the samples. And of course, if not assigned to any sub-class then it is classified as 100% outlier.

Where the outlier identification process does not exceed the distance threshold, then the original output classification of the trained classifier can be output to the associated applications (Block 313). If the outlier identification process does exceed the distance threshold, then the first input is designated as ‘unknown’ rather than the classification of the trained classifier (Block 315). The probability of the classification as unknown or as the initial classification can also be passed to the associated applications (Block 317).

Calibration

In some embodiments, a calibration process can be implemented to determine which layers/neurons of the NN are most relevant in determining outlier inputs. After creating the reference (base) probability distribution database, a calibration can be done to determine which neurons (or layers) are of most importance.

Each ML model (e.g., deep learning network) has a different architecture (i.e. number of layers and number of NN neurons per layer). Therefore, it is not possible to know a priori which neurons or layers are the ones of interest for the outlier classification process. Moreover, these layers may be different depending on the base class (e.g. for cats it may be neurons in layers 3 and 4 while for cars it may be neurons in layers 3 and 6).

The outlier identifier could optionally perform a calibration phase using the correctly labeled data. The idea is to determine the actual neurons/layers that have an impact (are relevant). As a possible solution, this can easily be done by using the computed distance. During the calculation of the entropy, the neuron values that caused the least increase in the entropy can be identified.

The calibration process can reduce the neurons considered during the outlier identification process to those neurons that are of most importance. The number of neurons kept is a hyperparameter that can be fine-tuned per sub-class. Once this is determined, the outlier identifier is optimized to only compare neuron activation results for those neurons. In another embodiment, outlier identifier could instead give a higher weight to those neurons that were more relevant. In some embodiments, the calibration process can be done per individual neurons, grouping of neurons or layers.

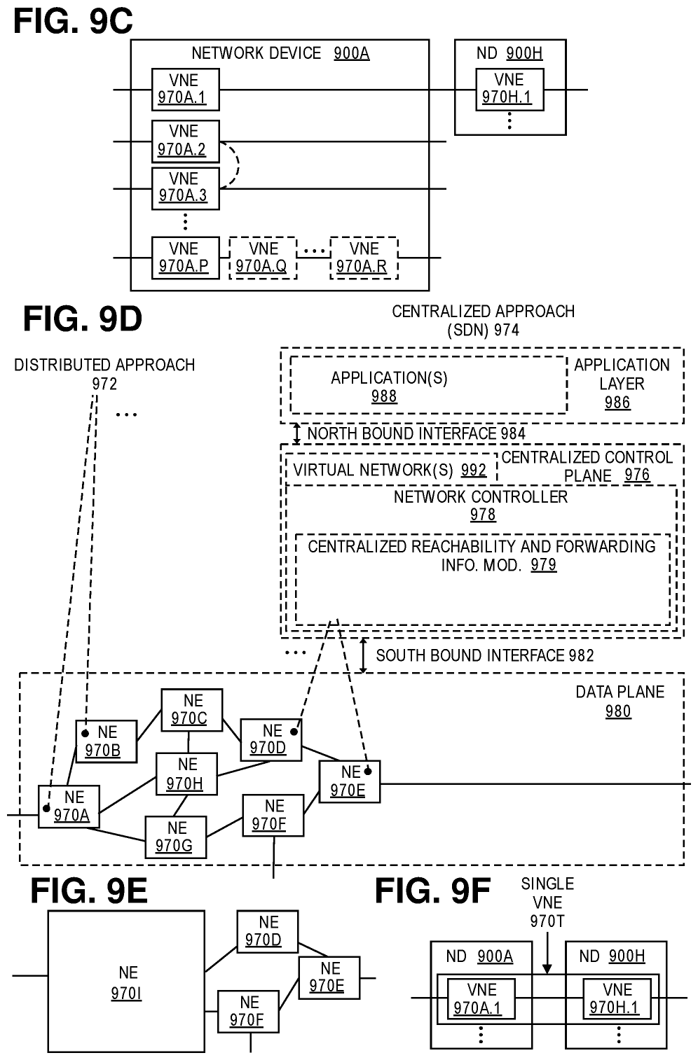

FIG. 9A illustrates connectivity between network devices (NDs) within an exemplary network, as well as three exemplary implementations of the NDs, according to some embodiments of the invention. FIG. 9A shows NDs 900A-H, and their connectivity by way of lines between 900A-900B, 900B-900C, 900C-900D, 900D-900E, 900E-900F, 900F-900G, and 900A-900G, as well as between 900H and each of 900A, 900C, 900D, and 900G. These NDs are physical devices, and the connectivity between these NDs can be wireless or wired (often referred to as a link). An additional line extending from NDs 900A, 900E, and 900F illustrates that these NDs act as ingress and egress points for the network (and thus, these NDs are sometimes referred to as edge NDs; while the other NDs may be called core NDs).

Two of the exemplary ND implementations in FIG. 9A are: 1) a special-purpose network device 902 that uses custom application—specific integrated—circuits (ASICs) and a special-purpose operating system (OS); and 2) a general purpose network device 904 that uses common off-the-shelf (COTS) processors and a standard OS.

The special-purpose network device 902 includes networking hardware 910 comprising a set of one or more processor(s) 912, forwarding resource(s) 914 (which typically include one or more ASICs and/or network processors), and physical network interfaces (NIs) 916 (through which network connections are made, such as those shown by the connectivity between NDs 900A-H), as well as non-transitory machine readable storage media 918 having stored therein networking software 920. In some embodiments, an outlier identifier 965 in combination with an ML model that may be applied network traffic handled by the device 902 or similarly utilized while stored in the non-transitory machine readable storage media 918. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

The special-purpose network device 902 is often physically and/or logically considered to include: 1) a ND control plane 924 (sometimes referred to as a control plane) comprising the processor(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the processor(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 936 (e.g., a first full mesh coupling the line cards and a second full mesh coupling all of the cards).

Returning to FIG. 9A, the general purpose network device 904 includes hardware 940 comprising a set of one or more processor(s) 942 (which are often COTS processors) and physical NIs 946, as well as non-transitory machine readable storage media 948 having stored therein software 950. During operation, the processor(s) 942 execute the software 950 to instantiate one or more sets of one or more applications 964A-R. In some embodiments, an outlier identifier 965 in combination with an ML model that may be applied network traffic handled by the device 904 or similarly utilized while stored in the non-transitory machine readable storage media 948. While one embodiment does not implement virtualization, alternative embodiments may use different forms of virtualization. For example, in one such alternative embodiment the virtualization layer 954 represents the kernel of an operating system (or a shim executing on a base operating system) that allows for the creation of multiple instances 962A-R called software containers that may each be used to execute one (or more) of the sets of applications 964A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 954 represents a hypervisor (sometimes referred to as a virtual machine monitor (VMM)) or a hypervisor executing on top of a host operating system, and each of the sets of applications 964A-R is run on top of a guest operating system within an instance 962A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 940, directly on a hypervisor (in which case the unikernel is sometimes described as running within a LibOS virtual machine), or in a software container, embodiments can be implemented fully with unikernels running directly on a hypervisor represented by virtualization layer 954, unikernels running within software containers represented by instances 962A-R, or as a combination of unikernels and the above-described techniques (e.g., unikernels and virtual machines both run directly on a hypervisor, unikernels and sets of applications that are run in different software containers).

The instantiation of the one or more sets of one or more applications 964A-R, as well as virtualization if implemented, are collectively referred to as software instance(s) 952. Each set of applications 964A-R, corresponding virtualization construct (e.g., instance 962A-R) if implemented, and that part of the hardware 940 that executes them (be it hardware dedicated to that execution and/or time slices of hardware temporally shared), forms a separate virtual network element(s) 960A-R.

The virtual network element(s) 960A-R perform similar functionality to the virtual network element(s) 930A-R—e.g., similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 962A-R to VNEs also apply to embodiments where such a finer level of granularity and/or unikernels are used.

In certain embodiments, the virtualization layer 954 includes a virtual switch that provides similar forwarding services as a physical Ethernet switch. Specifically, this virtual switch forwards traffic between instances 962A-R and the physical NI(s) 946, as well as optionally between the instances 962A-R; in addition, this virtual switch may enforce network isolation between the VNEs 960A-R that by policy are not permitted to communicate with each other (e.g., by honoring virtual local area networks (VLANs)).

The third exemplary ND implementation in FIG. 9A is a hybrid network device 906, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 9C illustrates various exemplary ways in which VNEs may be coupled according to some embodiments of the invention. FIG. 9C shows VNEs 970A.1-970A.P (and optionally VNEs 970A.Q-970A.R) implemented in ND 900A and VNE 970H.1 in ND 900H. In FIG. 9C, VNEs 970A.1-P are separate from each other in the sense that they can receive packets from outside ND 900A and forward packets outside of ND 900A; VNE 970A.1 is coupled with VNE 970H.1, and thus they communicate packets between their respective NDs; VNE 970A.2-970A.3 may optionally forward packets between themselves without forwarding them outside of the ND 900A; and VNE 970A.P may optionally be the first in a chain of VNEs that includes VNE 970A.Q followed by VNE 970A.R (this is sometimes referred to as dynamic service chaining, where each of the VNEs in the series of VNEs provides a different service—e.g., one or more layer 4-7 network services). While FIG. 9C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 9A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 9A may also host one or more such servers (e.g., in the case of the general purpose network device 904, one or more of the software instances 962A-R may operate as servers; the same would be true for the hybrid network device 906; in the case of the special-purpose network device 902, one or more such servers could also be run on a virtualization layer executed by the processor(s) 912); in which case the servers are said to be co-located with the VNEs of that ND.

A virtual network is a logical abstraction of a physical network (such as that in FIG. 9A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 9D illustrates a network with a single network element on each of the NDs of FIG. 9A, and within this straight forward approach contrasts a traditional distributed approach (commonly used by traditional routers) with a centralized approach for maintaining reachability and forwarding information (also called network control), according to some embodiments of the invention. Specifically, FIG. 9D illustrates network elements (NEs) 970A-H with the same connectivity as the NDs 900A-H of FIG. 9A.

FIG. 9D illustrates that the distributed approach 972 distributes responsibility for generating the reachability and forwarding information across the NEs 970A-H; in other words, the process of neighbor discovery and topology discovery is distributed.

For example, where the special-purpose network device 902 is used, the control communication and configuration module(s) 932A-R of the ND control plane 924 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 970A-H (e.g., the processor(s) 912 executing the control communication and configuration module(s) 932A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 924. The ND control plane 924 programs the ND forwarding plane 926 with information (e.g., adjacency and route information) based on the routing structure(s). For example, the ND control plane 924 programs the adjacency and route information into one or more forwarding table(s) 934A-R (e.g., Forwarding Information Base (FIB), Label Forwarding Information Base (LFIB), and one or more adjacency structures) on the ND forwarding plane 926. For layer 2 forwarding, the ND can store one or more bridging tables that are used to forward data based on the layer 2 information in that data. While the above example uses the special-purpose network device 902, the same distributed approach 972 can be implemented on the general purpose network device 904 and the hybrid network device 906.

FIG. 9D illustrates that a centralized approach 974 (also known as software defined networking (SDN)) that decouples the system that makes decisions about where traffic is sent from the underlying systems that forwards traffic to the selected destination. The illustrated centralized approach 974 has the responsibility for the generation of reachability and forwarding information in a centralized control plane 976 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 976 has a south bound interface 982 with a data plane 980 (sometime referred to the infrastructure layer, network forwarding plane, or forwarding plane (which should not be confused with a ND forwarding plane)) that includes the NEs 970A-H (sometimes referred to as switches, forwarding elements, data plane elements, or nodes). The centralized control plane 976 includes a network controller 978, which includes a centralized reachability and forwarding information module 979 that determines the reachability within the network and distributes the forwarding information to the NEs 970A-H of the data plane 980 over the south bound interface 982 (which may use the OpenFlow protocol). Thus, the network intelligence is centralized in the centralized control plane 976 executing on electronic devices that are typically separate from the NDs.

For example, where the special-purpose network device 902 is used in the data plane 980, each of the control communication and configuration module(s) 932A-R of the ND control plane 924 typically include a control agent that provides the VNE side of the south bound interface 982. In this case, the ND control plane 924 (the processor(s) 912 executing the control communication and configuration module(s) 932A-R) performs its responsibility for participating in controlling how data (e.g., packets) is to be routed (e.g., the next hop for the data and the outgoing physical NI for that data) through the control agent communicating with the centralized control plane 976 to receive the forwarding information (and in some cases, the reachability information) from the centralized reachability and forwarding information module 979 (it should be understood that in some embodiments of the invention, the control communication and configuration module(s) 932A-R, in addition to communicating with the centralized control plane 976, may also play some role in determining reachability and/or calculating forwarding information—albeit less so than in the case of a distributed approach; such embodiments are generally considered to fall under the centralized approach 974, but may also be considered a hybrid approach).

While the above example uses the special-purpose network device 902, the same centralized approach 974 can be implemented with the general purpose network device 904 (e.g., each of the VNE 960A-R performs its responsibility for controlling how data (e.g., packets) is to be routed (e.g., the next hop for the data and the outgoing physical NI for that data) by communicating with the centralized control plane 976 to receive the forwarding information (and in some cases, the reachability information) from the centralized reachability and forwarding information module 979; it should be understood that in some embodiments of the invention, the VNEs 960A-R, in addition to communicating with the centralized control plane 976, may also play some role in determining reachability and/or calculating forwarding information—albeit less so than in the case of a distributed approach) and the hybrid network device 906. In fact, the use of SDN techniques can enhance the NFV techniques typically used in the general purpose network device 904 or hybrid network device 906 implementations as NFV is able to support SDN by providing an infrastructure upon which the SDN software can be run, and NFV and SDN both aim to make use of commodity server hardware and physical switches.

FIG. 9D also shows that the centralized control plane 976 has a north bound interface 984 to an application layer 986, in which resides application(s) 988. The centralized control plane 976 has the ability to form virtual networks 992 (sometimes referred to as a logical forwarding plane, network services, or overlay networks (with the NEs 970A-H of the data plane 980 being the underlay network)) for the application(s) 988. Thus, the centralized control plane 976 maintains a global view of all NDs and configured NEs/VNEs, and it maps the virtual networks to the underlying NDs efficiently (including maintaining these mappings as the physical network changes either through hardware (ND, link, or ND component) failure, addition, or removal). In some embodiments, an outlier identifier 965 in combination with an ML model that may be applied network traffic handled by the SDN 974 or similarly utilized while stored in a non-transitory machine readable storage media.

While FIG. 9D shows the distributed approach 972 separate from the centralized approach 974, the effort of network control may be distributed differently or the two combined in certain embodiments of the invention. For example: 1) embodiments may generally use the centralized approach (SDN) 974, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 974, but may also be considered a hybrid approach.

While FIG. 9D illustrates the simple case where each of the NDs 900A-H implements a single NE 970A-H, it should be understood that the network control approaches described with reference to FIG. 9D also work for networks where one or more of the NDs 900A-H implement multiple VNEs (e.g., VNEs 930A-R, VNEs 960A-R, those in the hybrid network device 906). Alternatively or in addition, the network controller 978 may also emulate the implementation of multiple VNEs in a single ND. Specifically, instead of (or in addition to) implementing multiple VNEs in a single ND, the network controller 978 may present the implementation of a VNE/NE in a single ND as multiple VNEs in the virtual networks 992 (all in the same one of the virtual network(s) 992, each in different ones of the virtual network(s) 992, or some combination). For example, the network controller 978 may cause an ND to implement a single VNE (a NE) in the underlay network, and then logically divide up the resources of that NE within the centralized control plane 976 to present different VNEs in the virtual network(s) 992 (where these different VNEs in the overlay networks are sharing the resources of the single VNE/NE implementation on the ND in the underlay network).

On the other hand, FIGS. 9E and 9F respectively illustrate exemplary abstractions of NEs and VNEs that the network controller 978 may present as part of different ones of the virtual networks 992. FIG. 9E illustrates the simple case of where each of the NDs 900A-H implements a single NE 970A-H (see FIG. 9D), but the centralized control plane 976 has abstracted multiple of the NEs in different NDs (the NEs 970A-C and G-H) into (to represent) a single NE 9701 in one of the virtual network(s) 992 of FIG. 9D, according to some embodiments of the invention. FIG. 9E shows that in this virtual network, the NE 9701 is coupled to NE 970D and 970F, which are both still coupled to NE 970E.

FIG. 9F illustrates a case where multiple VNEs (VNE 970A.1 and VNE 970H.1) are implemented on different NDs (ND 900A and ND 900H) and are coupled to each other, and where the centralized control plane 976 has abstracted these multiple VNEs such that they appear as a single VNE 970T within one of the virtual networks 992 of FIG. 9D, according to some embodiments of the invention. Thus, the abstraction of a NE or VNE can span multiple NDs.

While some embodiments of the invention implement the centralized control plane 976 as a single entity (e.g., a single instance of software running on a single electronic device), alternative embodiments may spread the functionality across multiple entities for redundancy and/or scalability purposes (e.g., multiple instances of software running on different electronic devices).

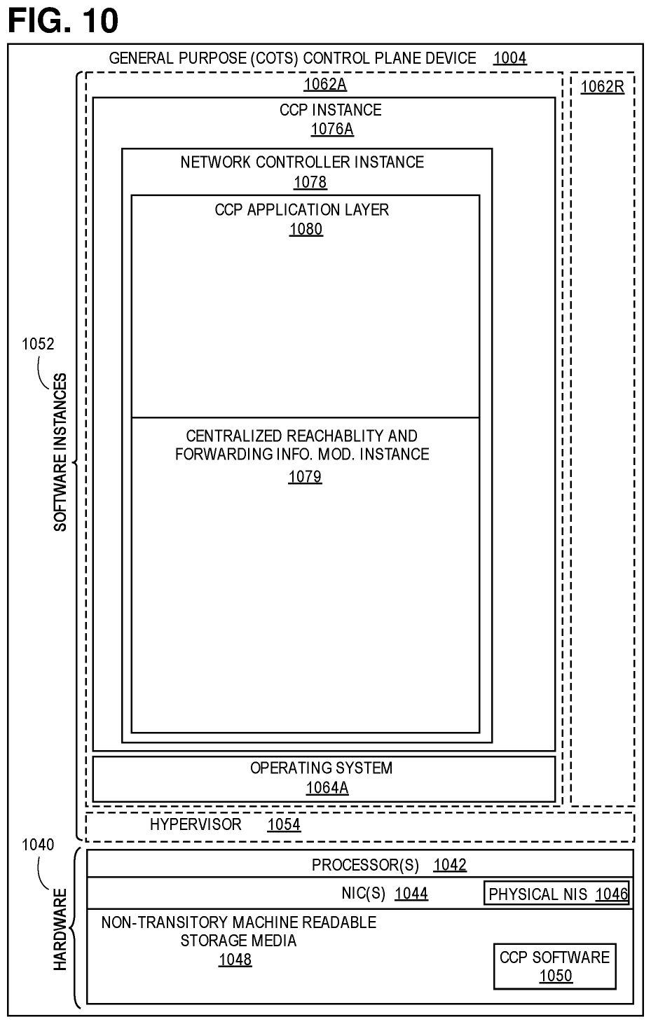

Similar to the network device implementations, the electronic device(s) running the centralized control plane 976, and thus the network controller 978 including the centralized reachability and forwarding information module 979, may be implemented a variety of ways (e.g., a special purpose device, a general-purpose (e.g., COTS) device, or hybrid device). These electronic device(s) would similarly include processor(s), a set or one or more physical NIs, and a non-transitory machine-readable storage medium having stored thereon the centralized control plane software. For instance, FIG. 10 illustrates, a general purpose control plane device 1004 including hardware 1040 comprising a set of one or more processor(s) 1042 (which are often COTS processors) and physical NIs 1046, as well as non-transitory machine readable storage media 1048 having stored therein centralized control plane (CCP) software 1050.

In embodiments that use compute virtualization, the processor(s) 1042 typically execute software to instantiate a virtualization layer 1054 (e.g., in one embodiment the virtualization layer 1054 represents the kernel of an operating system (or a shim executing on a base operating system) that allows for the creation of multiple instances 1062A-R called software containers (representing separate user spaces and also called virtualization engines, virtual private servers, or jails) that may each be used to execute a set of one or more applications; in another embodiment the virtualization layer 1054 represents a hypervisor (sometimes referred to as a virtual machine monitor (VMM)) or a hypervisor executing on top of a host operating system, and an application is run on top of a guest operating system within an instance 1062A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1040, directly on a hypervisor represented by virtualization layer 1054 (in which case the unikernel is sometimes described as running within a LibOS virtual machine), or in a software container represented by one of instances 1062A-R). Again, in embodiments where compute virtualization is used, during operation an instance of the CCP software 1050 (illustrated as CCP instance 1076A) is executed (e.g., within the instance 1062A) on the virtualization layer 1054. In embodiments where compute virtualization is not used, the CCP instance 1076A is executed, as a unikernel or on top of a host operating system, on the “bare metal” general purpose control plane device 1004. The instantiation of the CCP instance 1076A, as well as the virtualization layer 1054 and instances 1062A-R if implemented, are collectively referred to as software instance(s) 1052.

In some embodiments, the CCP instance 1076A includes a network controller instance 1078. The network controller instance 1078 includes a centralized reachability and forwarding information module instance 1079 (which is a middleware layer providing the context of the network controller 978 to the operating system and communicating with the various NEs), and an CCP application layer 1080 (sometimes referred to as an application layer) over the middleware layer (providing the intelligence required for various network operations such as protocols, network situational awareness, and user—interfaces). At a more abstract level, this CCP application layer 1080 within the centralized control plane 976 works with virtual network view(s) (logical view(s) of the network) and the middleware layer provides the conversion from the virtual networks to the physical view. In some embodiments, an outlier identifier 965 in combination with an ML model that may be applied to network traffic handled by the device 1004 or similarly utilized while stored in the non-transitory machine readable storage media 1048.

The centralized control plane 976 transmits relevant messages to the data plane 980 based on CCP application layer 1080 calculations and middleware layer mapping for each flow. A flow may be defined as a set of packets whose headers match a given pattern of bits; in this sense, traditional IP forwarding is also flow—based forwarding where the flows are defined by the destination IP address for example; however, in other implementations, the given pattern of bits used for a flow definition may include more fields (e.g., 10 or more) in the packet headers. Different NDs/NEs/VNEs of the data plane 980 may receive different messages, and thus different forwarding information. The data plane 980 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 980, the packet (or a subset of the packet header and content) is typically forwarded to the centralized control plane 976. The centralized control plane 976 will then program forwarding table entries into the data plane 980 to accommodate packets belonging to the flow of the unknown packet. Once a specific forwarding table entry has been programmed into the data plane 980 by the centralized control plane 976, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method for determining outlier inputs for a machine learning system, the method comprising:
receiving a classification and activation values of a trained classifier or a first input processed by the trained classifier;
determining whether an entropy score derived from the first input is below a threshold entropy-based distance metric; and
changing the classification in response to the entropy score not being below the threshold.

2. The method of claim 1, further comprising:
generating a reference probability distribution database from a training data set for the trained classifier.

3. The method of claim 2, further comprising:
calibrating the reference probability distribution database to reduce a number of activation values utilized for the method based on relevance of each of the activation values in identifying sub-classes of the classification.

4. The method of claim 1, wherein the determining whether the entropy score is below the threshold further comprises:
determining whether the entropy score is below the threshold of any one of a plurality of sub-classes of the classification.

5. The method of claim 4, further comprising:
sorting each item in a training data set into the plurality of sub-classes by using a clustering algorithm.

6. The method of claim 5, wherein a count is maintained of each item assigned to each sub-class.

7. The method of claim 1, wherein a threshold is managed as a hyperparameter for each sub-class of a plurality of sub-classes of the classification to assign items in a training data set to a respective sub-class that exceeds the threshold.

8. An electronic device to execute a method for determining outlier inputs for a machine learning system, the electronic device comprising:
a non-transitory computer-readable medium having stored therein an outlier identifier; and
a processor coupled to the non-transitory computer-readable medium, the processor to execute the outlier identifier, the outlier identifier to receive a classification and activation values of a trained classifier or a first input processed by the trained classifier, to determine whether an entropy score derived from the first input is below a threshold entropy-based distance metric, and to change the classification in response to the entropy score not being below the threshold.

9. The electronic device of claim 8, wherein the outlier identifier is further to generate a reference probability distribution database from a training data set for the trained classifier.

10. The electronic device of claim 9, wherein the outlier identifier is further to calibrate the reference probability distribution database to reduce a number of activation values utilized based on relevance of each of the activation values in identifying sub-classes of the classification.

11. The electronic device of claim 8, wherein the outlier identifier determines whether the entropy score is below the threshold by determining whether the entropy score is below the threshold of any one of a plurality of sub-classes of the classification.

12. The electronic device of claim 11, wherein the outlier identifier is further to sort each item in a training data set into the plurality of sub-classes by using a clustering algorithm.

13. The electronic device of claim 12, wherein a count is maintained of each item assigned to each sub-class.

14. The electronic device of claim 8, wherein a threshold is managed as a hyperparameter for each sub-class of a plurality of sub-classes of the classification to assign items in a training data set to a respective sub-class that exceeds the threshold.

15. A computing device to implement a plurality of virtual machines, the plurality of virtual machines to implement network function virtualization (NFV), where at least one virtual machine from the plurality of virtual machines implements a method for determining outlier inputs for a machine learning system, the computing device comprising:
a non-transitory computer-readable medium having stored therein a outlier identifier; and
a processor coupled to the non-transitory computer-readable medium, the processor to execute the at least one virtual machine from the plurality of virtual machines, the at least one virtual machine to execute the outlier identifier, the outlier identifier to receive a classification and activation values of a trained classifier or a first input processed by the trained classifier, to determine whether an entropy score derived from the first input is below a threshold entropy-based distance metric, and to change the classification in response to the entropy score not being below the threshold.

16. The computing device of claim 15, wherein the outlier identifier is further to generate a reference probability distribution database from a training data set for the trained classifier.

17. The computing device of claim 16, wherein the outlier identifier is further to calibrate the reference probability distribution database to reduce a number of activation values utilized based on relevance of each of the activation values in identifying sub-classes of the classification.

18. The computing device of claim 15, wherein the outlier identifier determines whether the entropy score is below the threshold by determining whether the entropy score is below the threshold of any one of a plurality of sub-classes of the classification.

19. The computing device of claim 18, wherein the outlier identifier is further to sort each item in a training data set into the plurality of sub-classes by using a clustering algorithm.

20. The computing device of claim 19, wherein a count is maintained of each item assigned to each sub-class.
